(19) United States
(12) Patent Application Publication
(10) Pub. No.: US 2017/0107096 A1
(43) Pub. Date: Apr. 20, 2017

(54) BRIDLE NOSEBAND

(71) Applicant: Charles Tota, Wellington, FL (US)

(72) Inventor: Charles Tota, Wellington, FL (US)

(21) Appl. No.: 15/261,317

(22) Filed: Sep. 9, 2016

Related U.S. Application Data
(60) Provisional application No. 62/242,027, filed on Oct. 15, 2015.

(51) Int. Cl. B68B 1/04

(52) U.S. Cl. CPC B68B 1/04

(57) ABSTRACT

A noseband for a horse bridle is specifically designed, structured and configured to direct the cheekpieces along the sides of the horse's face and away from the temporomandibular joint (TMJ) and nerves that run along the cheek bones, thereby avoiding TMJ damage, while also eliminating pressure at the horse's poll and back of the ears. A cheekstrap holds the cheekpieces snug against the opposite sides of the horse's face to discourage lateral (side-to-side) movement of the mandible (i.e., lower jaw) and undesirable displacement of the tongue out of the sides of the mouth while also assisting to hold the cheekpieces away from the TMJ and cheekbones.

### BACKGROUND OF THE INVENTION

This non-provisional patent application is based on provisional patent application Ser. No. 62/242,027 filed on Oct. 15, 2015.

### FIELD OF THE INVENTION

The present invention relates to bridles for horses and, more particularly, to a noseband or caveson that directs the cheekpieces away from the temporomandibular joint (TMJ) and nerves that run along the sides of a horse's face, while also eliminating poll pressure.

### DISCUSSION OF THE RELATED ART

A bridle fits over a horse's head and allows a rider to control and direct the horse with the use of reins and a bit fitted in the horse's mouth. A typical English style bridle includes a headstall (also referred to as a crownpiece or headpiece), cheekpieces, a browband, a throatlatch, a noseband (also referred to as a caveson), reins, and a bit.

The headstall goes over the horse's head, just behind the ears, at the poll. The cheekpieces attach to either side of the headstall and run down the sides of the horse's face and attach to the noseband and bit rings. The noseband encircles the nose and jaw of the horse and keeps the horse's mouth closed, while also allowing for attachment of the cheekpieces and other pieces or equipment (e.g., a martingale). The design of the classic English bridle, and particularly the noseband and headstall, directs the cheekpieces over (or very near) the TMJ and along the cheekbone. This causes constant and irritating pressure to the TMJ and the numerous facial nerves that run along the cheekbone. Additionally, the angle of the cheekpieces from the headstall to the noseband causes the headstall to exert pressure on the horse's poll and the backs of the ears. In response to the irritating pressure exerted by the bridle, and particularly the cheekpieces and headstall, many horses will try to open their mouth and move their head up and from side-to-side in an attempt to relieve the bridle pressure on the TMJ, facial nerves and poll. This interferes with the rider's ability to direct the horse and can significantly inhibit performance during competition (e.g., Dressage or Hunter/Jumper).

Over time, the pressure exerted by the classic English bridle can result in lumps and/or sores at the poll, as well as damage to the TMJ and facial nerves. Accordingly, there remains a longstanding and definite need for an improved bridle that eliminates poll pressure, as well as irritation and injury to the TMJ and facial nerves.

Objects and Advantages of the Invention

Considering the foregoing, it is a primary object of the present invention to provide an improved noseband for a bridle that eliminates poll pressure.

It is a further object of the present invention to provide an improved noseband for a bridle that eliminates TMJ damage.

It is still a further object of the present invention to provide an improved noseband for a bridle that avoids contact of the cheekpieces with the TMJ and nerves that run along a horse's cheekbones.

It is still a further object of the present invention to provide an improved noseband for a bridle that discourages and minimizes lateral (side-to-side) lower jaw movement.

It is yet a further object of the present invention to provide an improved noseband for a bridle that helps to prevent a horse from sticking their tongue out of the sides of their mouth.

It is still a further object of the present invention to provide an improved noseband for a bridle that provides significant comfort to the horse, while allowing for exceptional control and direction by the rider.

It is still a further object of the present invention to provide an improved noseband for a bridle that can significantly improve horse and rider performance during Dressage and Hunter/Jumper competitions.

These and other objects and advantages of the present invention are more readily apparent with reference to the following description and accompanying illustrations.

### BRIEF DESCRIPTION OF THE DRAWINGS

For a fuller understanding of the nature of the present invention, reference should be made to the following description taken in conjunction with the accompanying illustrations wherein:

FIG. 1 is a perspective view of the noseband of the present invention;

FIG. 2 is a side view showing the noseband of the present invention fitted on a horse's head, wherein the cheekpiece is shown to avoid the TMJ and cheekbones on the sides of the horse's face;

FIG. 3 is a side perspective view showing the noseband of the present invention installed to the bridle and fitted on a horse's head without the use of a conventional throat latch, and wherein the noseband is specifically designed to direct the cheekpieces away from (i.e., below) the TMJ and cheekbones on the opposite sides of the horse's face;

FIG. 4 is a side elevational view showing the noseband of the present invention installed on a bridle and fitted to a horse's head and including a conventional throat latch, and illustrating the cheekpieces being directed away from (i.e., below) the TMJ and cheekbones along the side of the horses face, while also providing advantageous direction between the cheekpieces and headstall to avoid poll pressure; and

FIG. 5 is a diagram of a horse's head showing the facial nerves and TMJ, and wherein the fitting of a conventional noseband and headstall is illustrated in broken lines to demonstrate areas of pressure at the poll, the connection of the browband, the TMJ and facial nerves extending along the cheekbones, as well as pressure on the nerves to the chin, jaw, lips and nostrils that results due to the design and structure of conventional nosebands.

### DESCRIPTION OF THE PREFERRED EMBODIMENT OF THE INVENTION

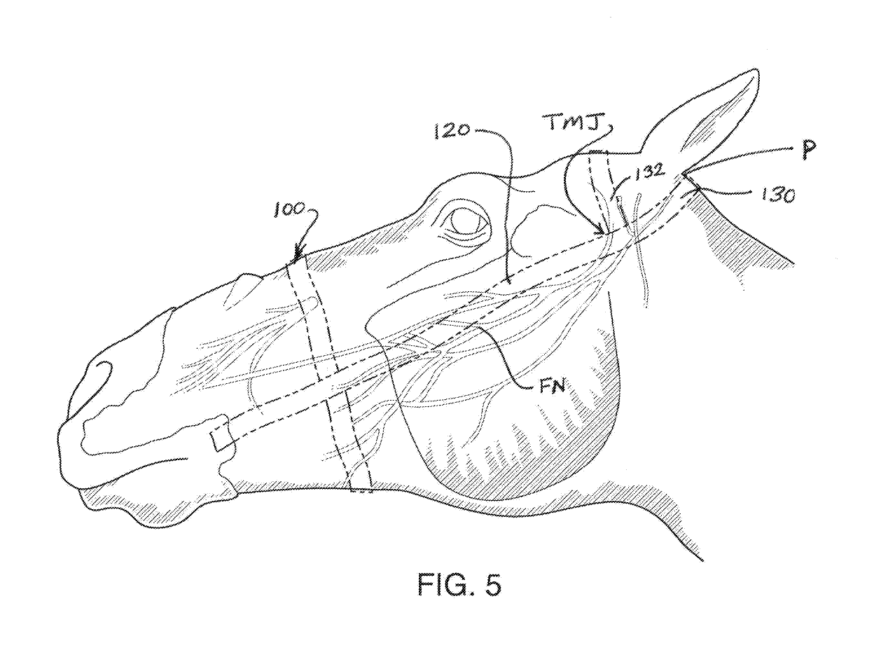

Referring initially to FIG. 5, an outline of a conventional noseband 100 and headstall 130 in the prior art is shown on a horse's head, wherein the cheekpieces 120 are seen to extend from the headstall 130 to the noseband 100 along the sides of the horse's face and, more particularly, over the TMJ and along the cheekbones. As seen in FIG. 5, there are a number of facial nerves FN that extend from the TMJ and along the cheekbones. The cheekpieces 120 and browband 132 of conventional bridles in the prior art apply pressure to the TMJ and facial nerves FN along the cheekbones. Moreover, the angle of extension of the cheekpieces 120 from the headstall 130 to the noseband 100 creates pressure on the poll P of the horse. As noted above, the positioning of the cheekpieces 120 of the conventional noseband and bridle causes damage to the TMJ, irritation of the facial nerves and significant pressure at the poll.

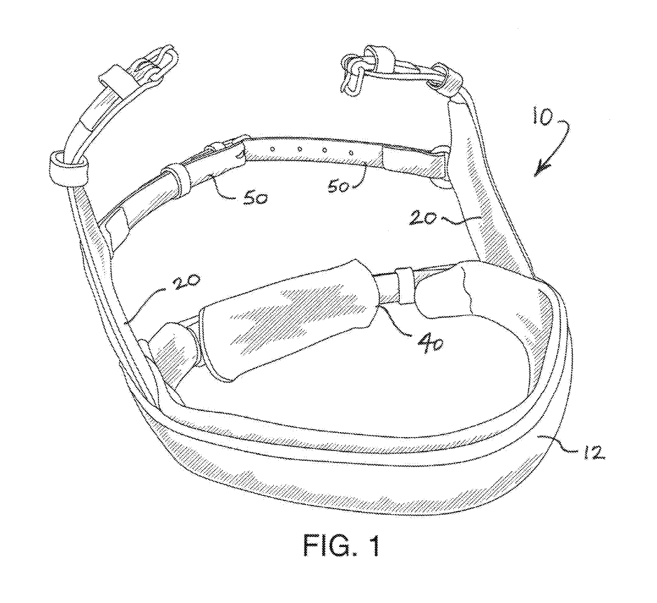

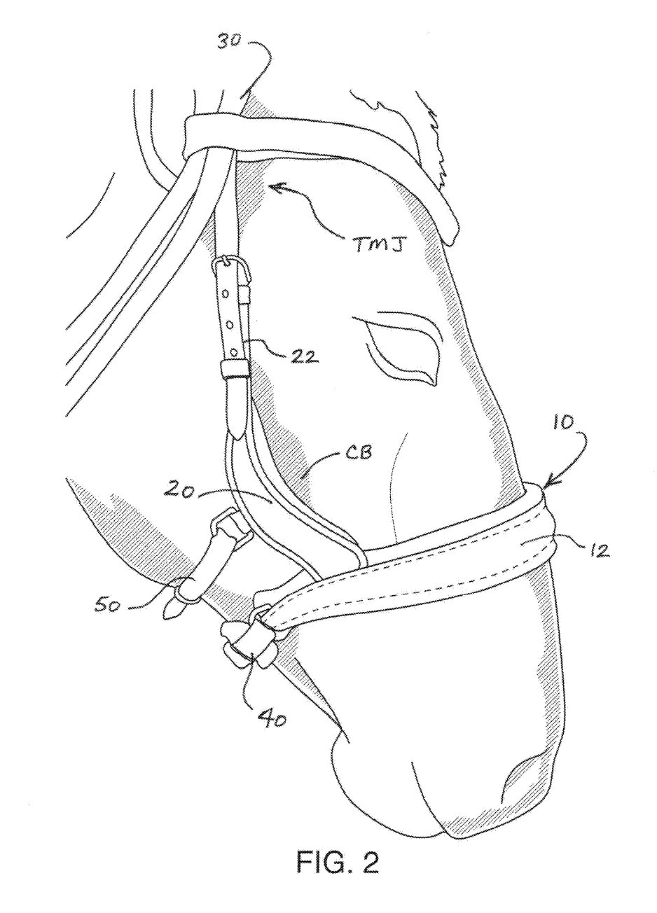

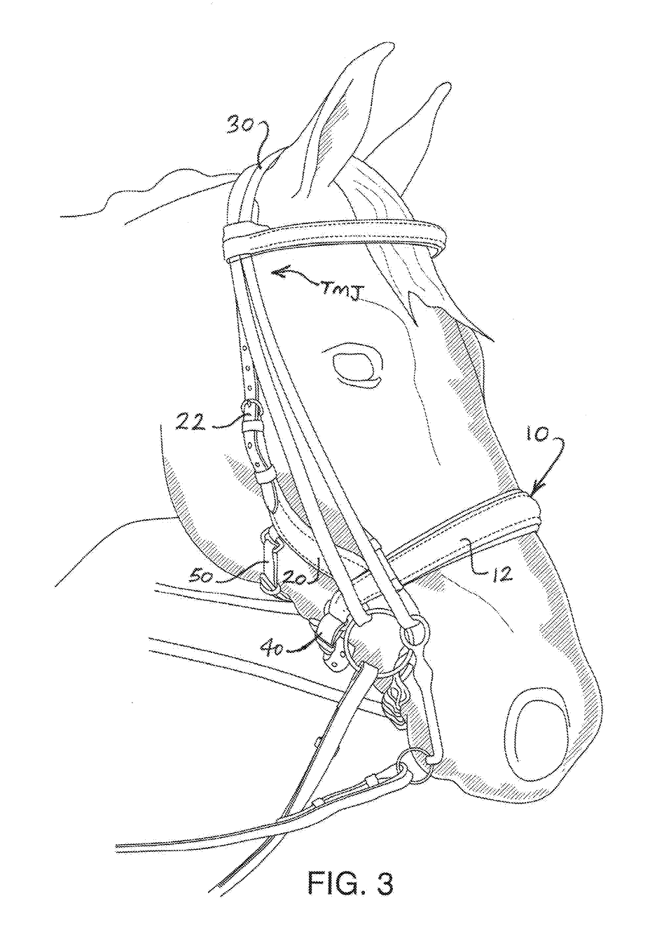

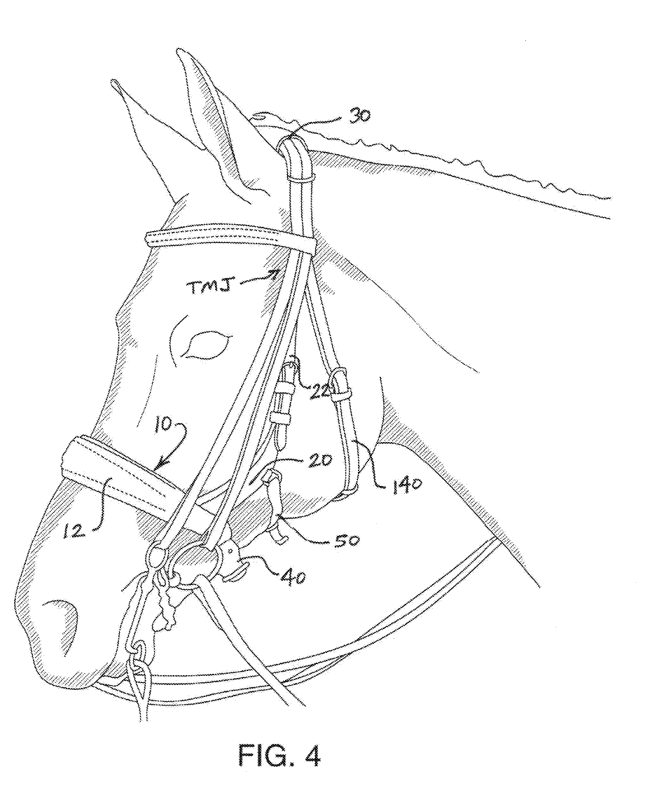

Referring now to FIGS. 2-4, the bridle noseband of the present invention is shown fitted to a horse and is generally indicated as 10. As seen in FIG. 2, the noseband 10 of the present invention includes an integral cheekpiece member 20 that extends initially downwardly below the horses cheekbone CB and then curves upwardly towards the headstall 30. Referring to FIG. 1, the noseband 10 of the present invention includes two of these cheekpiece members 20, one on each side, for positioning against the opposite left and right sides of the horse's face. A padded crank strap 40 adjustably fits and secures the noseband flash 12 snug around the nose and lower jaw of the horse. The noseband flash 12 is padded for comfort. The cheekpiece members 20 are specifically shaped and configured to avoid the cheekbones CB and to direct the cheekpieces 22 below and to the rear of the TMJ, as clearly seen in FIGS. 2-3. Strap members extend from the cheekpiece members and include conventional buckles for adjustable attachment to the cheekpieces 22 of the bridle. A second strap 50 secured to a mid-portion of the cheekpiece members 20 extends under the lower jaw of the horse and may be referred to as a secondary throatlatch or cheekstrap. The cheekstrap 50 is adjustably fitted and secured under the horse's jaw and holds the cheekpiece members 20 and cheekpieces 22 snug against the sides of the horse's face which helps to discourage lateral (i.e., side-to-side) movement of the horse's lower jaw. This secondary throatlatch or cheekstrap 50 can replace the need of a conventional throatlatch 140 (see FIG. 4) that is normally positioned further back towards the throat of the horse. In FIG. 3, the noseband 10 is shown installed to a bridle and fitted on a horse's head without the use of a conventional throatlatch. In this instance, the cheekstrap 50 is helping to hold the uniquely designed cheekpiece members 20 and the cheekpieces 22 (i.e., on both sides of the horse's head) away from the TMJ and cheekbones CB while also providing the function of a throatlatch. As seen in FIGS. 3 and 4, the cheekpiece members 20 provide an optimal angle of extension to the headstall 30 which helps to eliminate poll pressure.

The present invention has been shown and described in accordance with a preferred and practical embodiment. Departures from the instant disclosure are fully contemplated within the spirit and scope of the present invention.

What is claimed is:

1. A noseband for a horse bridle comprising:
a noseband flash and a crank strap extending from opposite ends of the noseband flash and the noseband flash and the crank strap being structured and disposed to be adjustably fitted and snugly secured around the nose and under the jaw of a horse;
left and right cheekpiece members attached to the noseband flash and the left and right cheekpiece members being structured and disposed for extending along left and right cheeks of the horse for connection to left and right cheekpieces of the horse bridle, and the left and right cheekpiece members being further structured, configured and disposed to extend below facial nerves of the horse and to direct the cheekpieces of the bridle away from the temporomandibular joints and nerves on opposite sides of the horses head; and
a cheek strap attached to the left and right cheekpiece members and structured and disposed to extend under the jaw of the horse rearward of the crank strap, and the cheek strap being adjustably fastenable to hold the cheekpiece members and the cheekpieces against the left and right cheeks and sides of the horse's face and away from the horse's facial nerves while also assisting to direct the cheekpieces of the bridle away from the horse's temporomandibular joints.

2. The noseband as recited in claim 1 wherein the crank strap includes a pad for engaging the horse under the horse's jaw.

3. The noseband as recited in claim 2 wherein the noseband flash is padded.

4. The noseband as recited in claim 1 wherein the left and right cheekpiece members are structured and disposed for adjustable attachment to the left and right cheekpieces of the horse bridal.
